(19) United States
(12) Patent Application Publication
(10) Pub. No.: US 2025/0315245 A1
(43) Pub. Date: Oct. 9, 2025

(54) METHOD FOR SOFTWARE UPDATE SCHEDULING SERVICE FOR A VEHICLE

(71) Applicants: HYUNDAI MOTOR COMPANY, Seoul (KR); KIA CORPORATION, Seoul (KR)

(72) Inventor: Seon-Il Noh, Hwaseong-si (KR)

(73) Assignees: HYUNDAI MOTOR COMPANY, Seoul (KR); KIA CORPORATION, Seoul (KR)

(21) Appl. No.: 18/946,504

(22) Filed: Nov. 13, 2024

(30) Foreign Application Priority Data
Apr. 4, 2024 (KR) 10-2024-0045881

(51) Int. Cl. G06F 8/65; B60W 50/00

(52) U.S. Cl. CPC G06F 8/65; B60W 50/00; B60W 2050/0075

(57) ABSTRACT

A method is disclosed for enabling a software update without a need for a user to directly control a vehicle. The method is performed by scheduling a time for an over-the-air (OTA) controller update function. The method includes: setting time scheduling for a software update for the vehicle through a cooperative controller by input from a user; checking, by a management controller, the set time scheduling to generate scheduled time information; sending, by the management controller, the scheduled time information to a management server; and remotely executing, by the management server, the software update for the vehicle on the management controller by using the scheduled time information.

### CROSS-REFERENCE TO RELATED APPLICATION

This application claims the benefit of and priority to Korean Patent Application No. 10-2024-0045881, filed on Apr. 4, 2024, the entire contents of which are incorporated herein by reference in its entirety.

### TECHNICAL FIELD

The present disclosure relates to software update technology and, more specifically, relates to a method for updating vehicle software at a scheduled time based on a vehicle condition.

### BACKGROUND

An over-the-air (OTA) controller update is a technology that wirelessly downloads software (i.e., firmware) and updates the software on a controller of a vehicle. In the OTA controller update, a ROM package for the controller is wirelessly downloaded, and then reprogramming of the controller is carried out when a vehicle ignition is turned off (IG-OFF).

During the period of the reprogramming, tuning on the vehicle ignition is restricted and the vehicle is unavailable for driving. For a controller with a small capacity, the reprogramming usually takes approximately 5 minutes. In contrast, if a controller has a large capacity or if there are many controllers, the reprogramming may take approximately 30 to 40 minutes.

For a controller using a basic compression method, the reprogramming does not take much time. Thus, the wireless download is completed even if a driver drives for a short time, and then the controller update is performed when the ignition is turned off.

However, for a memory redundancy controller, the wireless download and background send take approximately 20 to 30 minutes. Thus, the vehicle ignition should be turned on for a long time, or the vehicle should be driven for a certain period of time to carry out the controller reprogramming procedure after the ignition is turned off.

For example, for one controller (e.g., a Body Domain Controller, BDC), the ignition should be turned on for approximately 30 minutes. On the other hand, if two controllers (e.g., a Power net Domain Controller, PDC) are updated, the ignition should be turned on (IG-ON) for approximately 50 to 60 minutes.

In conclusion, the OTA controller update requires the user to turn on the ignition in an actual vehicle and drive for a certain period of time. In addition, the vehicle is unavailable for driving during the controller reprogramming.

In other words, with the related art, users should meet the conditions, required for

the OTA controller update, directly in the vehicle, which may lead to inconvenience. Thus, a method to resolve the issues is required. The subject matter described in this background section is intended to promote an understanding of the background of the disclosure and thus may include subject matter that is not already known to those of ordinary skill in the art.

### SUMMARY OF THE DISCLOSURE

The present disclosure is proposed to resolve the issues associated with the related art. An objective of the present disclosure is to provide a method, which may enable a software update without a need for a user to directly control a vehicle. The method is performed by scheduling a time for an over-the-air (OTA) controller update function.

To this end, the present disclosure provides a method, which may enable a software update without a need for a user to directly control a vehicle. The method is performed by scheduling a time for the OTA controller update function.

The method includes setting time scheduling for a software update for the vehicle through a cooperative controller by input from a user. The method also includes checking, by a management controller, the set time scheduling to generate scheduled time information. The method also includes sending, by the management controller, the scheduled time information to a management server. The method also includes remotely executing, by the management server, the software update for the vehicle on the management controller by using the scheduled time information.

In an embodiment, executing the software update includes sending, by the management server, a request, to the management controller, to remotely turn on an ignition based on a result of checking whether scheduled time derived from the scheduled time information has arrived. Executing the software update also includes sending, by the management controller, vehicle information and vehicle status information to the management server when the ignition of the vehicle is turned on (vehicle IG-ON) through the cooperative controller in response to the request to remotely turn on the ignition.

In an embodiment, sending the request to the management controller includes not performing an update approval, when the vehicle is driven until the arrival of the scheduled time and the ignition is turned off.

In an embodiment, remotely executing the software update includes remotely executing, by the management server, vehicle IG-ON based on the vehicle information and the vehicle status information when sending the vehicle information and the vehicle status information to the management server is completed. Remotely executing the software update also includes performing, by at least one execution controller, reprogramming for the software update for the vehicle.

In an embodiment, performing the reprogramming includes checking, by the management controller, vehicle condition information indicating a non-use state in which the vehicle is not directly controlled by the user. Performing the reprogramming also includes performing, by the management controller, the reprogramming or sending, by the management controller, alert information to a communication terminal, based on a result of the checking of the vehicle condition information.

In an embodiment, performing the reprogramming includes performing an update approval through the cooperative controller when the vehicle condition is satisfied based on the result of the checking of the vehicle condition information.

In an embodiment, the vehicle condition information includes at least one of door closed, headlamp-OFF, Electronic Parking Brake (EPB)-ON, or battery status.

In an embodiment, the vehicle information includes at least one of a vehicle model, a region, or a Vehicle Identification Number (VIN).

In addition, the vehicle status information includes at least one of a current software version for updating, download status of the software for updating, or vehicle battery status.

In an embodiment, setting the time scheduling includes providing on screen, by the cooperative controller, an option menu configured to allow the user to immediately start the software update or an option menu configured to allow the user to cancel the software update when the time scheduling is not set.

In an embodiment, the method also includes wirelessly downloading, by the management server, a current software for updating to the management controller before setting the time scheduling.

In an embodiment, wirelessly downloading the current software for updating to the management controller is performed by using a background send method.

The present disclosure may enable the OTA controller update to be performed during midnight or early morning hours when the vehicle is not in use, so that it is possible to avoid a situation where the vehicle is unavailable for use or should be continuously driven during work hours.

In addition, the present disclosure may also enable a software update during night hours, outside of work hours, when the user is in direct contact with the vehicle through setting a time schedule. Thus, convenience in terms of time may be increased.

In addition, the present disclosure may also increase ease of use by avoiding a situation where the vehicle is unavailable for use during an update through setting a time schedule.

In addition, the present disclosure may also enhance the user's ability to choose specific times by applying a function that allows the user to directly select an update time slot through setting a time schedule.

### BRIEF DESCRIPTION OF THE DRAWINGS

FIG. 1 is a block diagram of a configuration of a software update scheduling service system according to an embodiment of the present disclosure;

FIG. 2 is a block diagram of a detailed configuration of a management server illustrated in FIG. 1.

FIG. 3 is a block diagram of a detailed configuration of a management controller illustrated in FIG. 1.

FIG. 4 is a block diagram of a detailed configuration of a cooperative controller illustrated in FIG. 1.

FIG. 5 is a flowchart showing a process of data processing between respective components according to an embodiment of the present disclosure.

FIG. 6 is a flowchart showing a process of processing a software update scheduling service according to an embodiment of the present disclosure.

FIG. 7 is an example screen for setting an update schedule time according to an embodiment of the present disclosure.

### DESCRIPTION OF SPECIFIC EMBODIMENTS

The aforementioned objectives, features, and advantages of the present disclosure are described in detail below with reference to the accompanying drawings, and thus the technical spirit of the present disclosure should be readily implemented by those having ordinary skill in the art. In describing the present disclosure, when a detailed description of a known art related to the present disclosure is determined to unnecessarily obscure the gist of the present disclosure, the detailed description thereof has been omitted herein.

Embodiments of the present disclosure are described in detail below with reference to the accompanying drawings. The same reference numerals are used to indicate the same or similar components in the drawings. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

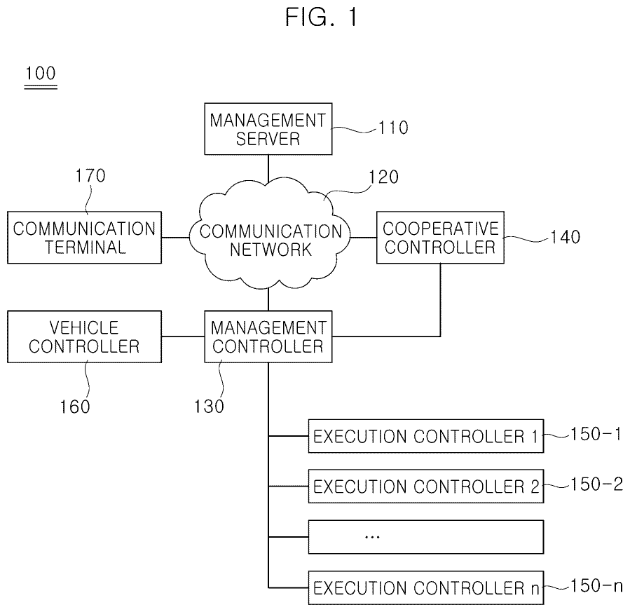

FIG. 1 is a block diagram of a configuration of a software update scheduling service system 100 according to an embodiment of the present disclosure. Referring to FIG. 1, the software update scheduling service system 100 may include a management server 110, a management controller 130, a cooperative controller 140, a plurality of execution controllers 150-1 to 150-n, a vehicle controller 160, a communication terminal 170, and the like.

The management server 110 performs a function of receiving vehicle information and vehicle status information from the management controller 130 of a vehicle and sending software for updating to the management controller 130 based on the vehicle information and the vehicle status information. Examples of the vehicle information may include a vehicle model, a region, a Vehicle Identification Number (VIN), and the like. In addition, examples of the vehicle status information may include a current software version for updating, download status of the software for updating, and vehicle battery status, and the like.

The management server 110 is communicatively connected to the management controller 130, the cooperative controller 140, and the like, which are configured in the vehicle through a communication network 120.

The communication network 120 may be Code Division Multiple Access (CDMA), Wideband Code Division Multiple Access (WCDMA), Wireless Broadband (WiBro), Wireless Fidelity (WiFi), Digital Living Network Alliance (DLNA), Zigbee, Z-Wave, a High-Speed Downlink Packet Access (HSDPA) network, Bluetooth, Radio Frequency Identification (RFID), Infrared Data Association (IrDA), Ultra-Wide Band, Wireless Universal Serial Bus (Wireless USB), a Near Field Communication (NFC) network, a satellite broadcasting network, an analog broadcasting network, a Digital Multimedia Broadcasting (DMB) network, and the like.

The management controller 130 performs a function of sending information on scheduled time, set by the user, to the management server 110. In addition, the management controller 130 collects vehicle information and vehicle status information and sends the same to the management server 110.

In addition, the management controller 130 checks the vehicle information and the vehicle status information, and then turns off a vehicle ignition and performs reprogramming procedure.

The cooperative controller 140 may be composed of a head unit and a controller that controls the vehicle ignition. The head unit performs a function of providing a time scheduling interface to the user. The head unit is installed in a center of a dashboard or in a console of the vehicle and provides an interface for the input and output of vehicle information, software update approval, time scheduling, and the like.

The vehicle ignition controller performs a function of controlling the vehicle ignition in response to a request from the management controller 130. A cooperative controller that controls the vehicle ignition may be a body control unit (BDC), and the like.

The first to n-th execution controllers 150-1 to 150-n perform a function of receiving software for updating from the management controller 130 and installing the same. To this end, the execution controllers 150-1 to 150-n are provided with a microprocessor, flash memory, and the like. Thus, the flash memory may function as programmable ready only memory (PROM), erasable PROM (EPROM), and the like, for updating and storing firmware.

Examples of the execution controllers 150-1 to 150-n may include an Electronic Control Unit (ECU) for engine control, an ECU for braking control, an ECU for steering control, an ECU for suspension control, a Battery Management System (BMS), a Tire Pressure Monitoring System (TPMS), a Motor Control Unit (MCU), and the like.

The vehicle controller 160 is a top-level controller of the vehicle and communicates with the execution controllers 150-1 to 150-N to send major vehicle commands for vehicle control, driving status determination, torque control, and the like. The vehicle controller 160 also sends vehicle status and/or location information to the management controller 130 and/or the cooperative controller 140 through a communication module. The cooperative controller 140 may receive the vehicle status and/or location information through the management controller 130.

The vehicle controller 160 may be a Vehicle Control Unit (VCU), a Hybrid Control Unit (HCU), and the like.

The communication terminal 170 may be linked to the communication network 120 to be communicatively connected to the management server 110 and/or the management controller 130. Thus, the user may send, through the communication terminal 170, a command to the management server 110 and/or the management controller 130 or may receive information from the management server 110 and/or the management controller 130.

The communication terminal 170 may be a Data Connectivity Unit (DCU), a mobile phone, a smartphone, a laptop computer, a terminal for digital broadcasting, a personal digital assistant (PDA), a portable multimedia player (PMP), a slate PC, a tablet PC, an Ultrabook, a wearable device, Notepad, and the like.

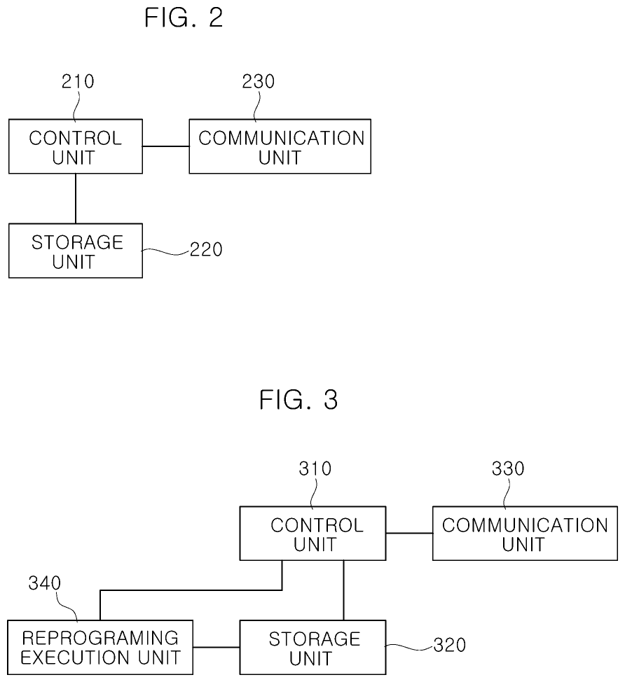

FIG. 2 is a block diagram of a detailed configuration of the management server 110 illustrated in FIG. 1. Referring to FIG. 2, the management server 110 may be configured to include a control unit 210, a storage unit 220, a communication unit 230, and the like.

The control unit 210 controls the components included in the management server 110 and remotely executes the software update function of the vehicle through the components during periods of time when the vehicle is not in use, such as midnight or early morning hours. Time information may be generated to check periods of time, or time information may be received from an external time server and synchronized with the time information generated in the control unit 210.

The storage unit 220 performs a function of storing vehicle information, vehicle status information, user information, scheduled time information, software for updating, and the like on a database. A program for operating and/or managing the management server 110, data related to the program, and the like may also be stored.

The communication unit 230 performs a function of being communicatively connected to the communication network 120.

FIG. 3 is a block diagram of a detailed configuration of the management controller 130 illustrated in FIG. 1. Referring to FIG. 3, the management controller 130 may be configured to include a control unit 310, a storage unit 320, a communication unit 330, reprogramming execution unit 340, and the like.

The control unit 310 performs a function of controlling a software update of the vehicle. More specifically, the control unit 310 performs a function of receiving information on a scheduled time selected by the user in conjunction with the cooperative controller 140 and sending the information to the management server 110.

In addition, the control unit 310 performs a function of collecting vehicle information, vehicle status information, and the like through the vehicle controller 160 and sending the information to the management server 110. The control unit 310 performs a function of receiving software for updating from the management server 110 at a scheduled time based on the vehicle information and the vehicle status information.

The storage unit 320 performs a function of storing a program for executing an algorithm to collect and store vehicle information, vehicle status information, user information, scheduled time information, identification information of each execution controller (e.g., Media Address Control (MAC), and the like.), and the like. The storage unit 320 performs a function of sending the information to the management server 110, sending data related to the program, and the like. The storage unit 320 performs a function of temporarily storing software for updating sent from the management server 110.

The reprogramming execution unit 340 performs a function of executing reprogramming for the first to n-th execution controllers 150-1 to 150-n. More specifically, the reprogramming execution unit 340 checks the software for updating and sends the same to a corresponding execution controller among the first to n-th execution controllers 150-1 to 150-n so that the reprogramming is performed. To this end, the reprogramming execution unit 340 may be configured to include a microprocessor, a microcontroller, and the like.

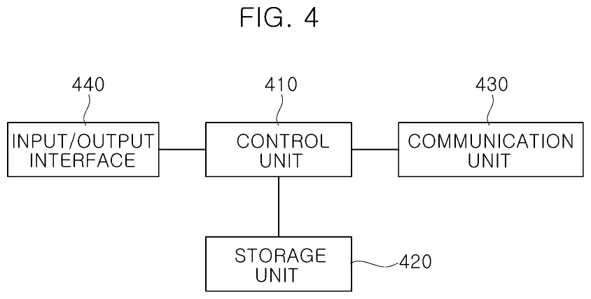

FIG. 4 is a block diagram of a detailed configuration of a cooperative controller 140 illustrated in FIG. 1. Referring to FIG. 4, the cooperative controller 140 may be configured to include a control unit 410, a storage unit 420, a communication unit 430, an input/output interface 440, and the like.

The control unit 410 provides a function to provide a screen, a button, system control, and the like for a variety of integrated information and entertainment functions. In addition, the control unit 410 sends a user command, which is input through the input/output interface 440, to the management controller 130. More specifically, when the user sets a scheduled time for a software update, information on the scheduled time is sent to the management controller 130.

The storage unit 420 performs a function of storing a program for a screen, a button and system control for integrated information and entertainment functions, and data related to the program.

The communication unit 430 performs a function of being communicatively connected to the communication network 120 and/or the management controller 130.

The input/output interface 440 performs a function of receiving a user command or outputting a screen, a voice, and the like for the user. To this end, the input/output interface 440 may be configured to include a display, a sound system, and the like.

The display may be a liquid crystal display (LCD), a light emitting diode (LED) display, an organic LED (OLED) display, a touch screen, a flexible display, a micro-LED, a mini-LED, a head-up display (HUD), and the like. The touch screen may be used as an output means as well as an input means. In addition, the sound system may be configured to include a speaker, a microphone, and the like.

The control units 210, 310, and 410 illustrated in FIGS. 2, 3, and 4 may be implemented as an application specific integrated circuit (SIC), digital signal processing (DSP), a programmable logic device (PLD), a field programmable gate array (FPGA), a processor, a microprocessor, another electronic unit, or a combination thereof.

In addition, the storage units 220, 320, and 420 may be configured with a combination of non-volatile memory such as flash memory disk (Solid State Disk, SSD), a hard disk drive, flash memory, electrically erasable programmable read-only memory (EEPROM), Static RAM (SRAM), Ferro-electric RAM (FRAM), Phase-change RAM (PRAM), Magnetic RAM (MRAM), and/or volatile memory such as Dynamic Random Access Memory (DRAM), Synchronous Dynamic Random Access Memory (SDRAM), Double Data Rate-SDRAM (DDR-SDRAM).

In addition, the communication units 230, 330, and 430 may be configured to include a microprocessor, a communication circuit, and the like.

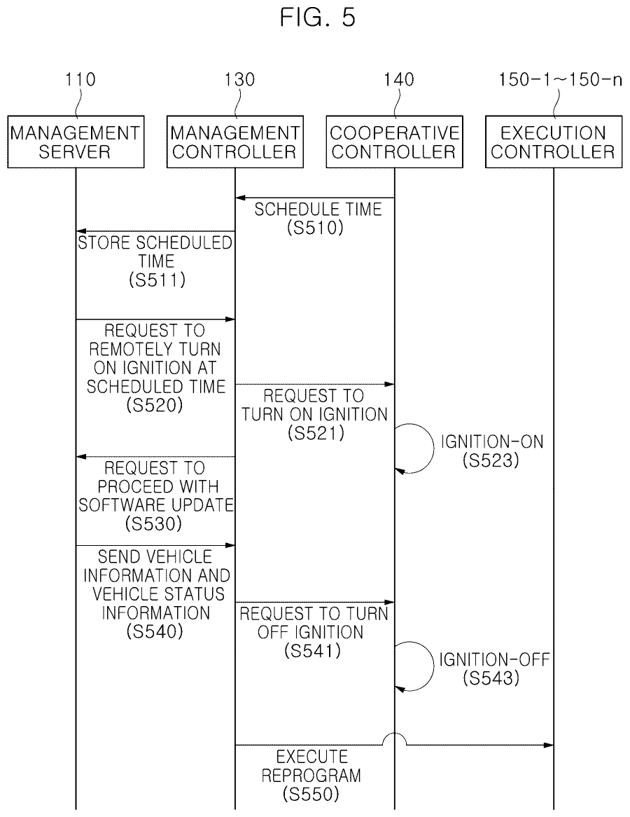

FIG. 5 is a flowchart showing a process of data processing between respective components according to an embodiment of the present disclosure. Referring to FIG. 5, a user sets time scheduling to execute a software update through a screen provided by the cooperative controller 140 (step S510). Before setting the time scheduling, software for updating is sent from the management server 110 to the management controller 130 as a background send.

The management controller 130 then checks the time scheduling, generates scheduled time information, and sends the scheduled time information to the management server 110 (step S511).

The management server 110 then receives the scheduled time information from the management controller 130 through the communication network 120 and stores the scheduled time information (step S511).

The management server 110 then sends a request to remotely turn on the vehicle ignition to the management controller 130 at the scheduled time based on the scheduled time information (step S520).

The management controller 130 then requests the cooperative controller 140 to turn on the vehicle ignition (vehicle IG-ON) for the software update (step S521).

Then, when the vehicle IG-ON is executed by the user through the cooperative controller 140 (step S523), the management controller 130 sends vehicle information and vehicle status information to the management server 110 (step S530). In this case, examples of the vehicle information may include a vehicle model, a region, a Vehicle Identification Number (VIN), and the like. In addition, examples of the vehicle status information may include a current software version for updating, download status of the software for updating, vehicle battery status, and the like.

The vehicle information may be sent from the management controller 130 to the management server 110 along with the scheduled time information in step S511. In addition, the current software version for updating among the vehicle status information may also be sent to the management server 110 in step S511.

The management server 110 then checks vehicle status and/or the vehicle status information and, based on the check result, sends a request to proceed with the software update to the management controller 130 (step S540).

More specifically, with the vehicle ignition turned on, the management server 110 collects the vehicle information and the vehicle status information sent from the management controller 130 and uses the collected vehicle status information to check the download status of the software for updating. The software for updating may be in the form of a package.

When the download of the software package is confirmed to be completed, the management controller 130 requests the cooperative controller 140 to turn off the ignition (IG-OFF) (step S541).

Then, when the user executes the IG-OFF through the cooperative controller 140 (S543), the management controller 130 executes reprogramming for a corresponding controller or corresponding controllers (step S550).

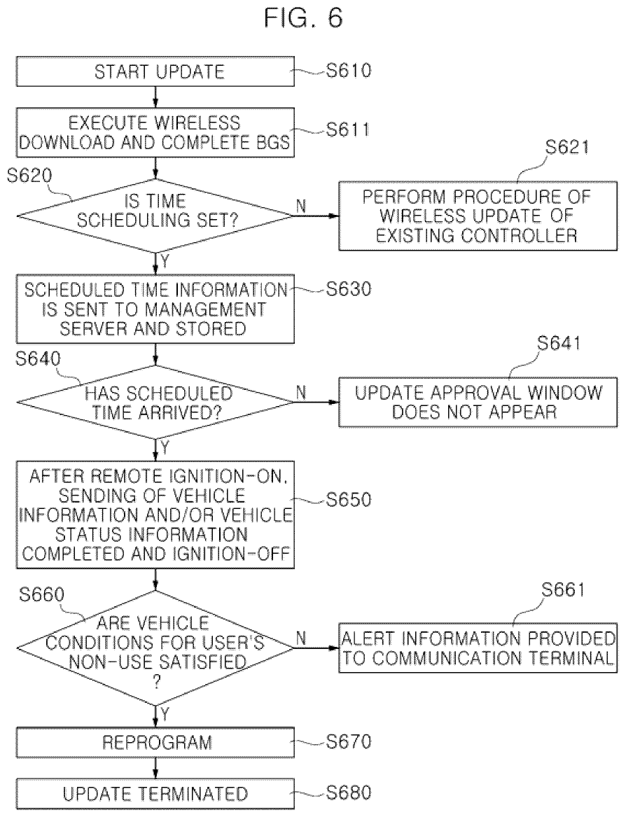

FIG. 6 is a flowchart showing a process of processing a software update scheduling service according to an embodiment of the present disclosure. Referring to FIG. 6, when a software update process starts, the user executes a wireless download for software for updating by driving the vehicle and completes a background send (BGS) (steps S610 and S611). In other words, the wireless download is performed by using a background send method. In other words, the background send method is a method of downloading a file in the background.

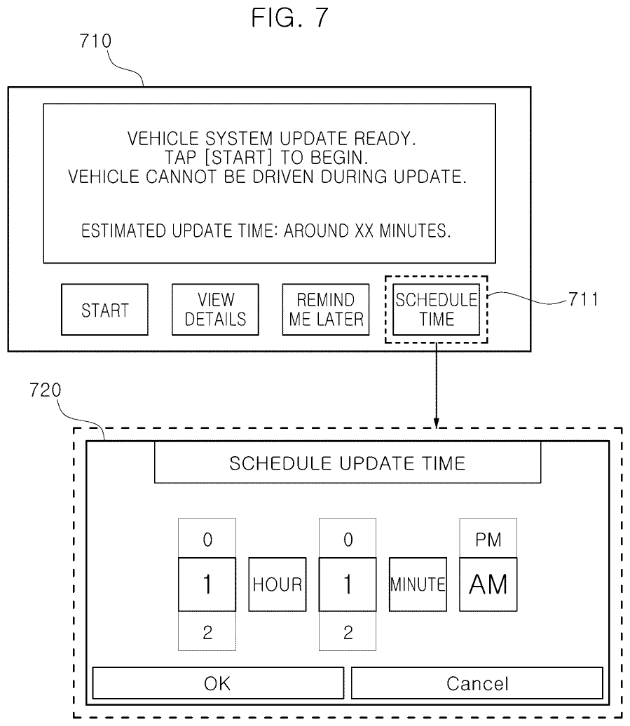

The cooperative controller 140 then checks whether the user sets time scheduling (step S620). More specifically, when the wireless download for the software for updating is completed, the cooperative controller 140 displays a message on a notification screen informing that the software update is ready. Accordingly, the user may set time scheduling using the notification screen. This is illustrated in FIG. 7. This is described below.

When the check result confirms that the time scheduling is not set (N in step S620), the management controller 130 performs a procedure of a conventional OTA controller update (step S621). More specifically, a “Start Now” option that allows the user to start the software update immediately or a “Cancel” option that allows the user to cancel the software update is provided on a screen of the cooperative controller 140.

When the check result confirms that the time scheduling is set (Y in step S620), the management controller 130 generates scheduled time information based on the setting of the time scheduling. The information is then sent to the management server 110 and stored (step S630). More specifically, when the time scheduling is set, the scheduled time is recognized by the management controller 130 and sent to the management server 110. The management server 110 then stores the scheduled time information in the storage unit 220.

The management server 110 then checks whether the scheduled time has arrived based on the scheduled time information (step S640).

When the check result confirms that the scheduled time has not arrived (N in step S640), the management controller 130 blocks a request for updating approval through the cooperative controller 140 to prevent the update approval from occurring (step S641). More specifically, if the ignition is turned on before the scheduled time arrives and then the ignition is turned off, the update approval is prevented from occurring.

In other words, even if the vehicle is driven until the arrival of the scheduled time and then the ignition is turned off so as to satisfy an update condition, the update approval is not performed.

In contrast, when the scheduled time arrives (Y in step S640), the vehicle ignition is remotely turned on, and the management controller 130 sends the vehicle information and/or the vehicle status information to the management server 110. When the sending is completed, the vehicle ignition is remotely turned off and the software update procedure starts (step S650).

The management controller 130 then uses vehicle condition information of the vehicle to determine whether cooperative control with the cooperative controller 140, the execution controllers 150-1 to 150-n, and the like is possible, e.g., whether the vehicle conditions for the user's non-use of the vehicle are satisfied (step S660).

More specifically, for the software update, it is necessary to check vehicle conditions that indicate a non-use state where the vehicle is not directly controlled by the user. Examples of the vehicle condition information include door closed, headlamp-OFF, Electronic Parking Brake (EPB)-ON, battery status, and the like.

Regarding the battery status, the downloaded software for updating should be installed only when the battery has sufficient charge to complete the software update. Thus, it is necessary to check the charge level through a battery status indicator such as State of Charge (SOC), State of Health (SOH), Depth of Discharging (DOD), and State of Function (SOF).

When the check result confirms that the vehicle conditions for the user's non-use of the vehicle are satisfied (Y in step S660), the management controller 130 proceeds with the update approval. More specifically, if a scheduled update procedure is set, an update approval pop-up window appears when the ignition is turned off. When receiving a corresponding signal from the cooperative controller 140, the management controller 130 processes an automatic approval and automatically performs the update. Accordingly, reprogramming is performed and the software update is terminated (steps S670 and S680).

In contrast, when the check result confirms that the vehicle conditions for the user's non-use of the vehicle are not satisfied (N in step S660), the management controller 130 provides alert information to the communication terminal 170 through the management server 110 (step S661). The alert information may contain a message stating “Update Cannot Be Performed.” Thus, the alarm information may be presented as text, voice, graphic, or a combination thereof.

FIG. 7 is an example screen for setting an update schedule time according to an embodiment of the present disclosure. Referring to FIG. 7, the management controller 130 communicates with the management server 110 and then downloads software for updating through a background send (BGS). After the background send is completed, when the user turns off the vehicle ignition, an update approval window 710 appears on the screen of the cooperative controller 140.

The update approval window 710 is configured with options including “Start,” “View Details,” “Remind Me Later,” and “Schedule Time.” In this case, the time scheduling may be set through a schedule time button 711.

If the user selects “Schedule Time” in the update approval window 710, a time scheduling window 720 appears as a pop-up window on the screen. In this case, the user may select “OK” or “Cancel.” When the management controller 130 receives an update approval signal from the cooperative controller 140, the management controller 130 requests the execution controllers 150-1 to 150-n to proceed with the reprogramming and automatically approves User Approval (UA).

More specifically, only when a scheduled time is set, the approval window 710 is displayed as a pop-up window. After the scheduled time is set, the approval window 710 is not displayed as a pop-up window and an update approval signal is automatically generated or is not generated.

In addition, the steps of the methods or algorithms described in connection with the embodiments disclosed herein may be implemented in the form of program instructions that may be executed by various computing means, such as a microprocessor, a processor, and a central processing unit (CPU), and recorded on a computer-readable medium. The computer-readable medium may include program (instruction) code, a data file, a data structure, and the like, either alone or in a combination thereof.

What is claimed is:

1. A method for a software update scheduling service for a vehicle, the method comprising:
setting time scheduling for a software update for the vehicle through a cooperative controller by input from a user;
checking, by a management controller, the set time scheduling to generate scheduled time information;
sending, by the management controller, the scheduled time information to a management server; and
remotely executing, by the management server, the software update for the vehicle on the management controller by using the scheduled time information.

2. The method of claim 1, wherein executing the software update comprises:
sending, by the management server, a request, to the management controller, to remotely turn on an ignition based on a result of checking whether scheduled time derived from the scheduled time information has arrived; and
sending, by the management controller, vehicle information and vehicle status information to the management server when the ignition of the vehicle is turned on (vehicle IG-ON) through the cooperative controller in response to the request to remotely turn on the ignition.

3. The method of claim 2, wherein sending the request to the management controller comprises not performing an update approval, when the vehicle is driven until the arrival of the scheduled time and the ignition is turned off.

4. The method of claim 2, wherein remotely executing the software update comprises:
remotely executing, by the management server, vehicle IG-ON based on the vehicle information and the vehicle status information when sending the vehicle information and the vehicle status information to the management server is completed; and
performing, by at least one execution controller, reprogramming for the software update for the vehicle.

5. The method of claim 4, wherein performing the reprogramming comprises:
checking, by the management controller, vehicle condition information indicating a non-use state in which the vehicle is not directly controlled by the user; and
performing, by the management controller, the reprogramming or sending, by the management controller, alert information to a communication terminal, based on a result of the checking of the vehicle condition information.

6. The method of claim 5, wherein performing the reprogramming comprises performing an update approval through the cooperative controller when a vehicle condition is satisfied based on the result of the checking of the vehicle condition information.

7. The method of claim 5, wherein the vehicle condition information comprises at least one of door closed, headlamp-OFF, Electronic Parking Brake (EPB)-ON, or battery status.

8. The method of claim 2, wherein the vehicle information comprises at least one of a vehicle model, a region, or a Vehicle Identification Number (VIN).

9. The method of claim 2, wherein the vehicle status information comprises at least one of a current software version for updating, download status of the software for updating, or vehicle battery status.

10. The method of claim 1, wherein setting the time scheduling comprises providing on screen, by the cooperative controller, an option menu configured to allow the user to immediately start the software update or an option menu configured to allow the user to cancel the software update when the time scheduling is not set.

11. The method of claim 1, further comprising:
wirelessly downloading, by the management server, a current software for updating to the management controller before setting the time scheduling.

12. The method of claim 11, wherein wirelessly downloading the current software for updating to the management controller is performed by using a background send method.
